(19) United States
(12) Patent Application Publication
(10) Pub. No.: US 2026/0359598 A1
(43) Pub. Date: Nov. 12, 2026

(54) AUTONOMOUS AGENTIC SYSTEM FOR ARTIFICIAL LIFT ISSUE DETECTION AND ACTION

(71) Applicant: Schlumberger Technology Corporation, Sugar Land, TX (US)

(72) Inventors: Kaustubh Shrivastava, Houston, TX (US); Felipe Klein, Houston, TX (US); Nikhil Choudhary, London (GB); Garud Bindiganavale Sridhar, Houston, TX (US); Adam Niven Shumaker, Houston, TX (US); Hoang Phi-Dung Vo, Sugar Land, TX (US)

(21) Appl. No.: 19/674,894

(22) Filed: May 12, 2026

Related U.S. Application Data
(60) Provisional application No. 63/804,215, filed on May 12, 2025.

(51) Int. Cl. G06N 3/042; E21B 43/12

(52) U.S. Cl. CPC G06N 3/042; E21B 43/128

(57) ABSTRACT

A method for detecting, analyzing, and resolving a problem with an artificial lift includes receiving input data related to the artificial lift. The method also includes identifying an anomaly in the input data using an edge device. The method also includes identifying the problem based upon the anomaly using a large language model (LLM) in a cloud. The method also includes determining a solution to the problem using the LLM. The method also includes generating a recommendation for implementing the solution using the LLM.

### CROSS-REFERENCE TO RELATED APPLICATIONS

This application claims priority to U.S. Provisional Patent Application No. 63/804,215, filed on May 12, 2025, which is incorporated by reference.

### BACKGROUND

Electrical submersible pumps (ESP) are widely used in oil and gas production but are prone to failures caused by electrical and mechanical issues. Most failures in ESPs stem from electrical or mechanical stress that gradually degrade their components. The electrical stresses often result from electrical distortions introduced either by variable frequency drives (VFDs) or the electricity source, which may result in localized heading, winding degradation, and eventual failure. If left unaddressed, these may result in costly repairs and downtime. Identifying these electrical distortions currently involves specialized expertise, which may be time-consuming, often resulting in a delay in resolution of the issues, leading to damage to the pumps. Therefore, what is needed is an improved system and method for detecting and resolving issues with ESPs (e.g., used in artificial lifts).

### SUMMARY

A method for detecting, analyzing, and resolving a problem with an artificial lift is disclosed. The method includes receiving input data related to the artificial lift. The method also includes identifying an anomaly in the input data using an edge device. The method also includes identifying the problem based upon the anomaly using a large language model (LLM) in a cloud. The method also includes determining a solution to the problem using the LLM. The method also includes generating a recommendation for implementing the solution using the LLM.

In another embodiment, the method includes receiving input data related to the artificial lift. The input data is related to an electric submersible pump (ESP) that is part of the artificial lift. The ESP is located in a well. The input data includes metrics including voltage, current, pressure, flow rate, or a combination thereof. The method also includes identifying an anomaly in the input data using an edge device. The anomaly is identified using an edge artificial intelligence (AI) agent. The anomaly includes a fluctuation in one or more of the metrics, a shift in a pattern in one or more of the metrics, an outlier that deviates from an expected norm for one or more of the metrics, or a combination thereof. The method also includes identifying the problem based upon the anomaly using a large language model (LLM) in a cloud. The LLM includes one or more cloud AI agents. The one or more cloud agents include react agents (RAs) that use a reasoning and acting framework. The problem is identified using a first of the one or more cloud AI agents. The first cloud AI agent identifies the problem by correlating symptoms across multiple channels, data sources, and/or time-series input data. The problem is related to a pump, a valve, a gas lock, a flow that is less than a flow threshold, or a combination thereof. The method also includes determining a solution to the problem using the LLM. The the solution is determined using a second of the one or more cloud AI agents. The second cloud AI agent integrates a knowledge bank as retrieval-augmented generation (RAG). The method also includes generating a recommendation for implementing the solution using the LLM. The recommendation is generated using a third of the one or more cloud AI agents. The recommendation is quantitative and qualitative. The recommendation includes adjusting a gas injection rate for the artificial lift, adjusting a speed of the ESP, repairing or replacing a portion of the artificial lift, or a combination thereof. The portion includes the pump, the valve, the gas lock, or a combination thereof. The method also includes implementing the recommendation using the edge device. The recommendation is implemented using the edge AI agent. Implementing the recommendation includes generating or transmitting a signal that instructs or causes the recommendation to be physically implemented.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a schematic view of a system for detecting and resolving issues with ESPs (e.g., used in artificial lifts), according to an embodiment.

FIG. 3 illustrates a flowchart of another method for detecting, analyzing, and resolving a problem with an artificial lift, according to an embodiment.

FIG. 4 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

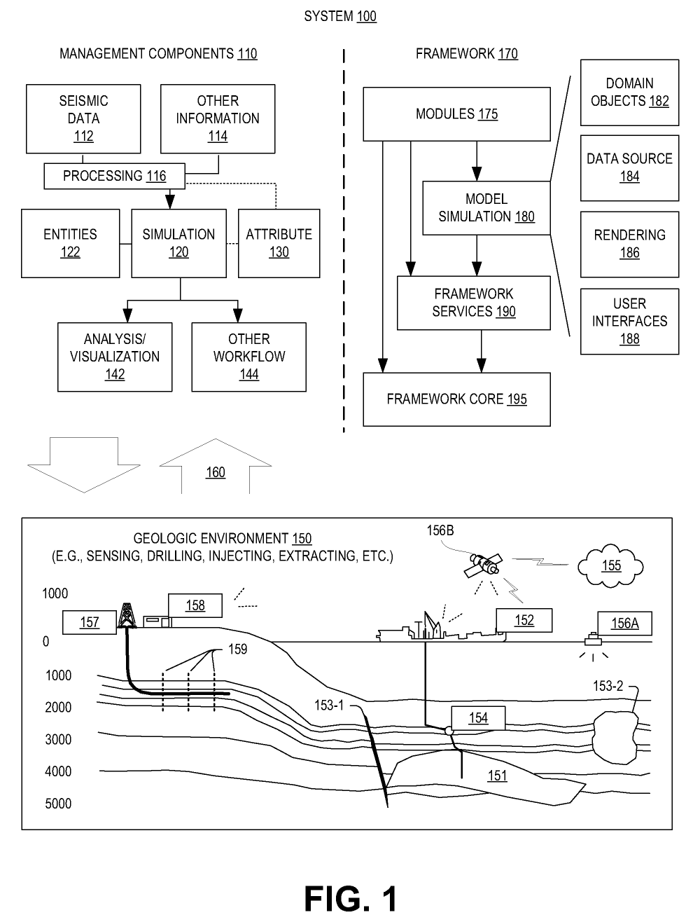

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

### Artificial Lift Copilot: Autonomous Agentic System for Artificial Lift Issue Detection and Action

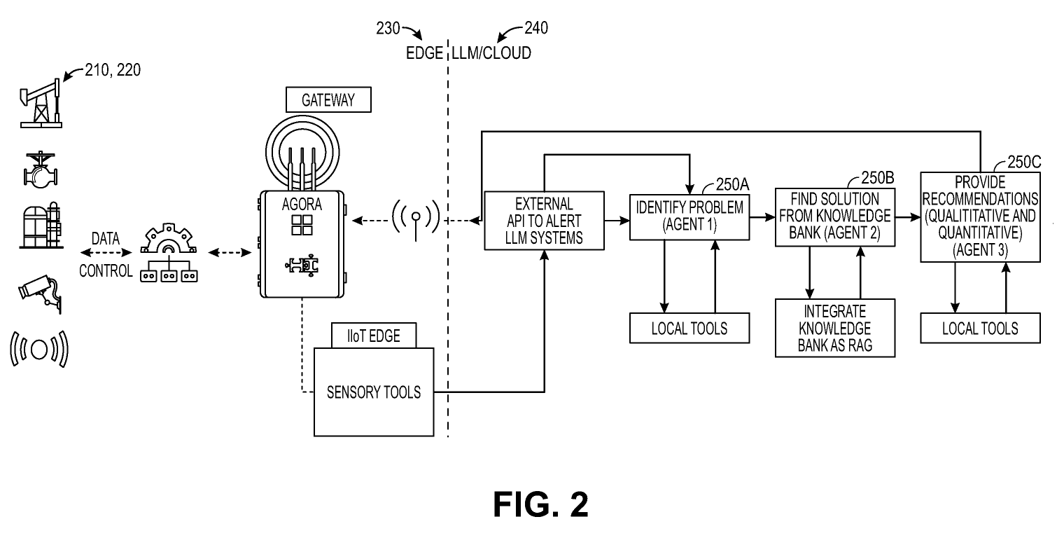

FIG. 2 illustrates a schematic view of a system for detecting and resolving issues with ESPs (e.g., used in artificial lifts), according to an embodiment. The system is a real-time agentic system that leverages reasoning abilities and embedded knowledge bank using retrieval augmented generation (RAG) to detect issues in power signals (e.g., by deploying tools in the Agora® Edge gateway). This solution may be extended to act like a copilot for artificial lift systems that track the performance of artificial lifts in real time and diagnose issues. A control system may be integrated to close the loop so that the decisions taken using the analysis may be looped back to take action on the edge device.

The present disclosure may enhance the understanding of an autonomous agentic system by leveraging a rich repository of expert knowledge. This may be achieved by capturing and distilling insights from subject matter experts and transforming them into a structured expertise library. The method may integrate this knowledge, enabling it to make more informed decisions and improve its reasoning capabilities.

The method includes a multi-agent workflow that leverages a distributed architecture that incorporates tools inside the edge gateway to monitor data in real-time, enabling continuous analysis and detection of patterns, trends, and anomalies. These agents may use tools to scan the data stream to identify shifts in patterns, fluctuations in metrics, and outliers that deviate from expected norms. The tools may be designed to execute algorithms on the edge device and extract insights that may be used for further analysis by a large language model (LLM)-based reasoning engine that is situated on the cloud.

The agent in the cloud orchestrates the execution of tools to execute various tasks, such as execution of algorithms and insights extraction, generation of relevant plots, generation of reports, etc. These agents may be integrated with local resources available to them, such as databases or machine learning algorithms, to investigate further by correlating symptoms across multiple channels and data sources.

The method may effectively detect and respond to emerging patterns and anomalies. By leveraging the strengths of each agent and combining their expertise with advanced technologies, the method is both accurate and effective, providing real-time insights and guidance to support informed decision-making.

The method may use react agents (RAs). These are AI-driven decision-making systems that use the reasoning + acting (ReAct) framework to interact with tools iteratively. The RAs reason about the task, take an action, and observe the results. This process may be repeated until the goal is achieved. These types of agents form the foundation for the three agents that may be developed in this solution.

The method may also use retrieval-augmented generation (RAG). This may enable the agents to dynamically fetch relevant information from the knowledge bank to generate more accurate and context-aware responses.

The method may also use natural language processing (NLP). The NLP may be used by agents to parse text-based inputs, understand the nature of anomalies, and provide targeted solutions.

The method may also use correlation algorithms to understand whether the observation is reflected in other time series data. The correlation algorithms may also be used to identify similarity in anomalies detected in multiple time series.

The method may provide real-time issue detection and resolution in ESP systems and other artificial lift systems. The method may also allow for expert-level knowledge to be democratized across the workforce, so that engineers may perform at expert levels. The method may also provide scalable and repeatable solutions that may be tailored for specific equipment and fields. The method may overcome the challenges encountered by conventional troubleshooting methods, which often rely on manual effort and limited data analysis. The method described herein may reduce the processing time so that it provides expert level analysis in real-time. The method may also provide a custom analysis by the equipment by looking at the history of the equipment.

The method may analyze data using an autonomous multi-agentic system. This system leverages AI techniques, including React Agents, RAG, NLP, and correlation algorithms, to detect anomalies, provide solutions, and ensure a self-sustaining smart loop. The method utilizes the power of large language models (LLMs) and ESP systems to create an intelligent troubleshooting system. By capturing expert insights from subject matter specialists and distilling them into a structured library, the method may make informed decisions and improve its reasoning capabilities. This approach allows for real-time processing of data, enabling engineers to diagnose and resolve challenges quickly and efficiently. Unlike conventional methods, the method described herein may leverage historical data and past events to provide context, reducing manual effort.

The method may be extended to other artificial lift systems and/or other equipment. It may enable users to execute custom algorithms by writing these algorithms in natural language. It may provide insights currently in the form of report, but it may be extended to work in a control systems mode where it takes action on the edge device based on the insights that it has generated.

The method may provide real-time analysis and decision-making capabilities. The method may also provide democratization of expert knowledge across the workforce. The method may also provide scalability and repeatability of solutions. The method may also provide reduced data transmission from edge devices, as insights may be extracted at the edge device level itself. The method may also provide a real business impact by enhancing operational intelligence, reducing time to detection, and democratizing expert knowledge across the enterprise, making troubleshooting faster, smarter, and more efficient. The method may accelerate issue detection and resolution. For example, it may enable users to quickly identify and diagnose issues that often involve expert intervention. The method may also identify root causes more efficiently. For example, it may use an AI-driven analysis to highlight patterns and trends that a human might miss, especially in case where an individual is monitoring large number of wells. The method may also provide development of a custom knowledge bank. For example, it may capture expert knowledge in a structured format for future referencing and training, democratizing expert knowledge across the workforce. The method may also scale beyond single equipment. For example, it may generate and/or use a standardized workflow that may be adapted across basins and across multiple equipment types, making the workflow truly scalable. The method may also provide conversational insights. For example, it may provide a conversational interface that allows users to efficiently monitor and manage large fields without deep expertise. The method may also provide efficient data handling. For example, streaming processed data from sensory tools may reduce the need to stream high volume of data, which may be beneficial in a bandwidth-constrained environment. Agents deployed on the gateway may be leveraged to further improve the decision-making process.

The method may provide faster issue detection and resolution times. The method may also provide improved operational intelligence and decision-making capabilities. The method may also provide an analysis done at edge itself, reducing the cost of data transmission. The method may also provide faster algorithm design-to-deployment. The method may also generate algorithms from insights from older reports. The method may also provide democratization of expert-level knowledge across the workforce. The method may also provide scalability and repeatability of solutions for different artificial lift solutions. The method may also provide advanced AI-driven analysis and anomaly detection.

The method may be used as a copilot for artificial lift systems (e.g., ESPs). The method may provide insights based on real-time data that may help even junior engineers to operate at expert levels by getting expert level advice from the system. They may leverage the inbuilt knowledge bank that distills knowledge gathered from experts to obtain insights and understand their systems better. This system may also be fully automated so that the reasoning capabilities of LLMs may be leveraged to develop smart control systems that extract insights at the edge, reducing the cost of data transmission.

### Exemplary Method

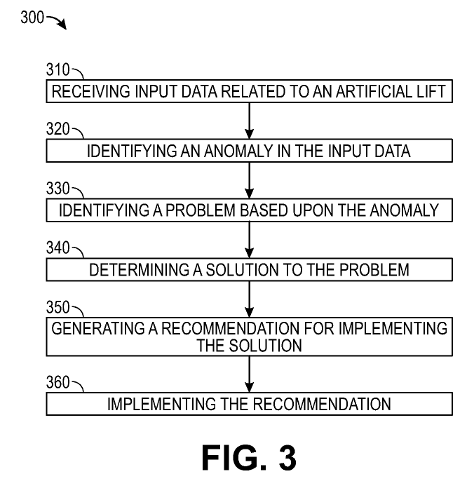

FIG. 3 illustrates a flowchart of another method 300 for detecting, analyzing, and resolving a problem with an artificial lift, according to an embodiment. An illustrative order of the method 300 is provided below; however, one or more portions of the method 300 may be performed in a different order, simultaneously, repeated, or omitted. At least a portion of the method 300 may be performed using a computing system.

The method 300 may include receiving input data related to the artificial lift 210, as at 310. The input data may be related to an electric submersible pump (ESP) 220 that is part of the artificial lift 210. The ESP 220 may be located in a well. The input data may include metrics such as voltage, current, pressure, flow rate, or a combination thereof.

The method 300 may also include identifying an anomaly in the input data, as at 320. The anomaly may be identified using an edge device 230. The anomaly may be identified using an edge artificial intelligence (AI) agent. The anomaly may be or include a fluctuation in one or more of the metrics, a shift in a pattern in one or more of the metrics, an outlier that deviates from an expected norm for one or more of the metrics, or a combination thereof.

The method 300 may also include identifying the problem based upon the anomaly, as at 330. The problem may be identified using a large language model (LLM) 240 in a cloud. The LLM 240 may include one or more cloud AI agents 250A-250C. The one or more cloud agents 250A-250C may be or include react agents (RAs) that use a reasoning and acting framework. The problem may be identified using a first of the one or more cloud AI agents 250A. The first cloud AI agent 250A may identify the problem by correlating symptoms across multiple channels, data sources, and/or time-series input data. In an example, the problem may be related to a pump (e.g. the ESP 220 or another pump in the artificial lift), a valve, a gas lock, a flow that is less than a flow threshold, or a combination thereof.

The method 300 may also include determining a solution to the problem, as at 340. The solution may be determined using the LLM 240. The solution may be determined using a second of the one or more cloud AI agents 250B. The second cloud AI agent 250B may integrate a knowledge bank as retrieval-augmented generation (RAG).

The method 300 may also include generating a recommendation for implementing the solution, as at 350. The recommendation may be generated using the LLM 240. The recommendation may be generated using a third of the one or more cloud AI agents 250C. The recommendation may be quantitative and/or qualitative. In an example, the recommendation may include adjusting a gas injection rate for the artificial lift 210, adjusting a speed of the ESP 220, repairing or replacing a portion of the artificial lift 210, or a combination thereof. The portion may be or include the pump, the valve, the gas lock, or a combination thereof.

The method 300 may also include implementing the recommendation, as at 360. The recommendation may be implemented using the edge device 230. The recommendation may be implemented using the edge AI agent. Implementing the recommendation may include generating or transmitting a signal that instructs or causes the recommendation to be physically implemented. In another embodiment, implementing the recommendation may include performing a physical action (e.g., adjusting the gas injection rate, adjusting the speed, repairing or replacing the portion, etc.).

### Exemplary Computing System

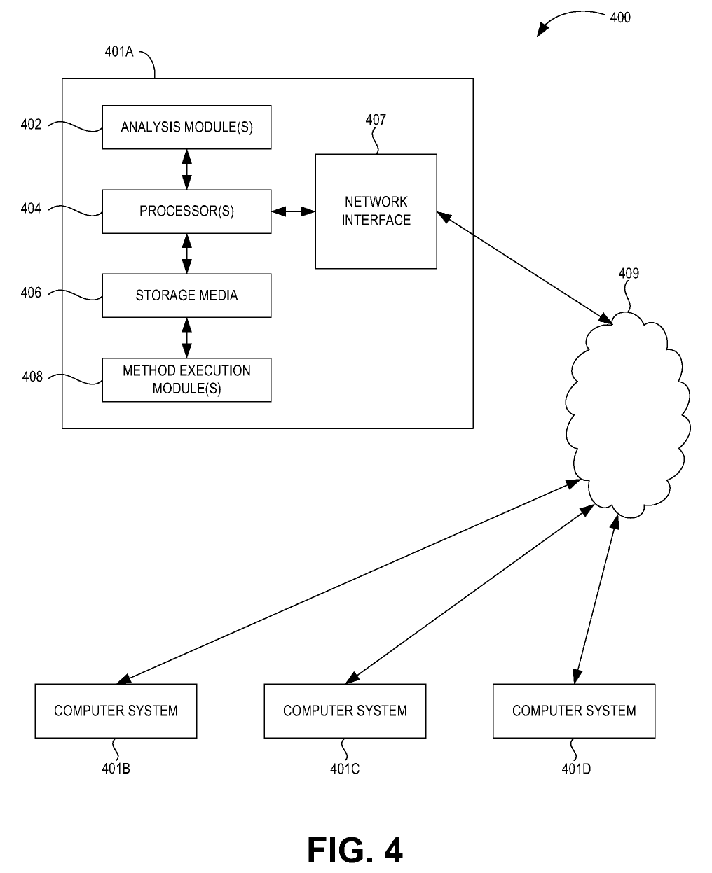

In some embodiments, the methods of the present disclosure may be executed by a computing system. FIG. 4 illustrates an example of such a computing system 400, in accordance with some embodiments. The computing system 400 may include a computer or computer system 401A, which may be an individual computer system 401A or an arrangement of distributed computer systems. The computer system 401A includes one or more analysis modules 402 that are configured to perform various tasks according to some embodiments, such as one or more methods disclosed herein. To perform these various tasks, the analysis module 402 executes independently, or in coordination with, one or more processors 404, which is (or are) connected to one or more storage media 406. The processor(s) 404 is (or are) also connected to a network interface 407 to allow the computer system 401A to communicate over a data network 409 with one or more additional computer systems and/or computing systems, such as 401B, 401C, and/or 401D (note that computer systems 401B, 401C and/or 401D may or may not share the same architecture as computer system 401A, and may be located in different physical locations, e.g., computer systems 401A and 401B may be located in a processing facility, while in communication with one or more computer systems such as 401C and/or 401D that are located in one or more data centers, and/or located in varying countries on different continents).

A processor may include a microprocessor, microcontroller, processor module or subsystem, programmable integrated circuit, programmable gate array, or another control or computing device.

The storage media 406 may be implemented as one or more computer-readable or machine-readable storage media. Note that while in the example embodiment of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 400 contains one or more method execution module(s) 408. In the example of computing system 400, computer system 401A includes the method execution module 408. In some embodiments, a single method execution module may be used to perform some aspects of one or more embodiments of the methods disclosed herein. In other embodiments, a plurality of method execution modules may be used to perform some aspects of methods herein.

It should be appreciated that computing system 400 is merely one example of a computing system, and that computing system 400 may have more or fewer components than shown, may combine additional components not depicted in the example embodiment of FIG. 4, and/or computing system 400 may have a different configuration or arrangement of the components depicted in FIG. 4. The various components shown in FIG. 4 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 400, FIG. 4), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for detecting, analyzing, and resolving a problem with an artificial lift, the method comprising:
receiving input data related to the artificial lift;
identifying an anomaly in the input data using an edge device;
identifying the problem based upon the anomaly using a large language model (LLM) in a cloud;
determining a solution to the problem using the LLM; and
generating a recommendation for implementing the solution using the LLM.

2. The method of claim 1, wherein the input data is related to an electric submersible pump (ESP) that is part of the artificial lift.

3. The method of claim 1, wherein the input data comprises metrics including voltage, current, pressure, flow rate, or a combination thereof.

4. The method of claim 3, wherein the anomaly comprises a fluctuation in one or more of the metrics, a shift in a pattern in one or more of the metrics, an outlier that deviates from an expected norm for one or more of the metrics, or a combination thereof.

5. The method of claim 1, wherein the anomaly is identified using an edge artificial intelligence (AI) agent.

6. The method of claim 1, wherein the problem is related to a pump, a valve, a gas lock, a flow that is less than a flow threshold, or a combination thereof.

7. The method of claim 1, wherein the LLM comprises one or more cloud AI agents, and wherein the problem is identified using a first of the one or more cloud AI agents.

8. The method of claim 7, wherein the one or more cloud agents comprise react agents (RAs) that use a reasoning and acting framework.

9. The method of claim 7, wherein the first cloud AI agent identifies the problem by correlating symptoms across multiple channels, data sources, and/or time-series input data.

10. The method of claim 7, wherein the solution is determined using a second of the one or more cloud AI agents.

11. The method of claim 10, wherein the second cloud AI agent integrates a knowledge bank as retrieval-augmented generation (RAG).

12. The method of claim 10, wherein the recommendation is generated using a third of the one or more cloud AI agents.

13. The method of claim 1, wherein the recommendation is quantitative and qualitative.

14. The method of claim 1, wherein the recommendation comprises adjusting a gas injection rate for the artificial lift or adjusting a speed of an electric submersible pump (ESP) that is part of the artificial lift.

15. The method of claim 1, wherein the recommendation comprises repairing or replacing a portion of the artificial lift, and wherein the portion comprises a pump, a valve, a gas lock, or a combination thereof.

16. The method of claim 1, further comprising implementing the recommendation.

17. The method of claim 16, wherein the recommendation is implemented using the edge device.

18. The method of claim 16, wherein implementing the recommendation comprises generating or transmitting a signal that instructs or causes the recommendation to be physically implemented.

19. A computing system, comprising:
one or more processors; and
a memory system comprising one or more non-transitory computer-readable media storing instructions that, when executed by at least one of the one or more processors, cause the computing system to perform operations, the operations comprising:
receiving input data related to an artificial lift;
identifying an anomaly in the input data using an edge device;
identifying a problem based upon the anomaly using a large language model (LLM) in a cloud;
determining a solution to the problem using the LLM; and
generating a recommendation for implementing the solution using the LLM.

20. A non-transitory computer-readable medium storing instructions that, when executed by one or more processors of a computing system, cause the computing system to perform operations, the operations comprising:
receiving input data related to an artificial lift;
identifying an anomaly in the input data using an edge device;
identifying a problem based upon the anomaly using a large language model (LLM) in a cloud;
determining a solution to the problem using the LLM; and
generating a recommendation for implementing the solution using the LLM.
